(19) United States
(12) Patent Application Publication
(10) Pub. No.: US 2008/0183007 A1
(43) Pub. Date: Jul. 31, 2008

(54) Process For the Preparation of Alkyl Phosphinic Acids

(75) Inventor: Mats Thelin, Sodertalje (SE)

Correspondence Address: WHITE & CASE LLP;PATENT DEPARTMENT, 1155 AVENUE OF THE AMERICAS, NEW YORK, NY, 10036, US

(73) Assignee: ASTRAZENECA AB, Sodertalje (SE)

(21) Appl. No.: 11/576,826

(22) PCT Filed: Oct. 5, 2005
(86) PCT No.: PCT/SE05/01470

§ 371 Date: Apr. 6, 2007

(30) Foreign Application Priority Data
Oct. 8, 2004 (SE) 0402462-6

(51) Int. Cl. C07F 9/30

(52) U.S. Cl. 562/8

(57) ABSTRACT

The present invention relates to a new process for the synthesis of alkyl phosphinic acids, and more particularly to a coupling reaction between an alkylhalide and a hypophosphorous acid derivative by a radical initiated reaction. The invention also relates to compounds obtainable by the method of the invention.

### FIELD OF THE INVENTION

The present invention relates to a new process for the synthesis of alkyl phosphinic acids, and more particularly to a coupling reaction between an alkyl halide and a hypophosphorous acid derivative by a radical initiated reaction. The invention also relates to compounds obtainable by the process of the invention.

### BACKGROUND OF THE INVENTION

Reactions between an alkyl halide and the hypophosphorous acid derivative, bis(trimethylsilyl) hypophosphite, is previously known from K. Issleib et al., Z. anorg. Allg. Chem. 530 (1985), pp. 16-28.

A radical initiated reaction between a hypophosphorous acid and an alkene is disclosed in Deprèle, S., et al, J. Org. Chem., 2001, 66, 6745-6755. The reaction is a radical addition of hypophosphites to olefins and the radical reaction is initiated by trialkylboranes and oxygen.

Winqvist A., et al., Eur. J. Org. Chem., 2002, 1509-1515, describe, inter alia, synthesis of phosphinic acids from alkyl halides and bis(trimethylsilyl)-hypophosphite. The publication describes the influence of the temperature during the reaction.

WO 01/42252 discloses aminopropylphosphinic acids and the synthesis thereof. The synthesis described is a stepwise reaction starting from a substituted serine compound.

Many initiators in the collection of suitable radical initiators require heat addition for initiating the reaction. Also oxygen can be used as an initiator for a radical reaction. However, some of the hypophosphorous acid derivatives are pyrophoric and therefore oxygen is not a suitable initiator. One such example is the hypophosphorous acid derivative bis-trimethylsilyl hypophosphite.

Chemical radical initiators would be possible for initiating the reaction between an alkyl halide and a hypophosphorous acid derivative. Most often, when such initiators are used, the reaction is started by raising the temperature of the reaction mixture. However, temperature is also a critical parameter for reduction of the amount of by-products, the lower temperature the lower amount of by-products. The disadvantage of lowering the temperature is that also the reaction rate is reduced at a low temperature, and this has implications for the result and the yield of the desired product. Therefore, there is a need for a process where the amount of by-products obtained are kept low in parallel with a fast and efficient reaction rate.

### OUTLINE OF THE INVENTION

The present invention provides a new process for the preparation of alkyl phosphinic acids and salts thereof. More particularly, the present invention is directed to a new process for the preparation of an alkyl phosphinic acid, whereby an alkyl halide is reacted with a hypophosphorous acid derivative by a radical initiated reaction.

In one embodiment, the alkyl phosphinic acid is synthesised by a process comprising the following steps:
a) forming a hypophosphorous acid derivative;
b) adding an alkyl halide to the product of step a); and
c) initiating the radical reaction.

In one embodiment, a compound of formula I

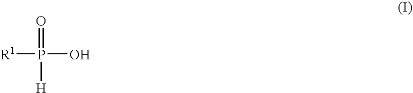

wherein

R¹ is selected from a C₁-C₁₆ alkyl optionally substituted or interrupted by one or more substituents selected from linear or branched C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine or chlorine; or

R¹ is selected from a C₁-C₁₆ alkylamine optionally substituted or interrupted by C₁-C₁₀ alkyl, cyclic C₃-C₆ alkyl, aryl, heteroaryl, hydroxy, mercapto, C₁-C₁₀ alkoxy, C₁-C₁₀ thioalkoxy, fluorine or chlorine;

is prepared by reacting a compound of formula II

R¹—X (II)

wherein R¹ is as defined above and X represents a halogen selected from bromide or iodine;

with a hypophosporous acid derivative, said reaction being radical initiated.

Is In a further embodiment of the present invention, a compound of formula III

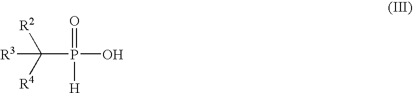

wherein

R² is selected from

a C₁-C₁₀-alkyl optionally substituted or interrupted by one or more substituents selected from C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine or chlorine; or

a C₁-C₁₀-alkylamine optionally substituted by one or more substituents selected from C₁-C₁₀ alkyl, aryl, heteroaryl, hydroxy, mercapto, C₁-C₁₀ alkoxy, C₁-C₁₀ thioalkoxy, fluorine or chlorine;

R³ and R⁴ are each and independently selected from

a C₁-C₆-alkyl optionally substituted or interrupted by one or more substituents selected from C₁-C₆ alkyl, cyclic C₃-C₆ alkyl, aryl, heteroaryl, hydroxy, oxo, mercapto, C₁-C₆ alkoxy, C₁-C₆ thioalkoxy, fluorine or chlorine; or

a C₁-C₆ alkylamine optionally substituted or interrupted by one or more substituents selected from C₁-C₁₀ alkyl, aryl, heteroaryl, hydroxy, mercapto, C₁-C₁₀ alkoxy, C₁-C₁₀ thioalkoxy, fluorine or chlorine;

or hydrogen;

is prepared by reacting a compound of formula IV

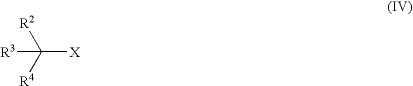

wherein

R², R³ and R⁴ are each and independently defined as above, and X represents a halogen selected from bromide or iodine;

with a hypophosphorous acid derivative, said reaction being radical initiated.

In still a further embodiment of the invention, a compound of formula V

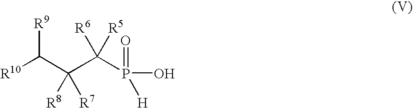

wherein

R⁵ and R⁶ are each and independently selected from hydrogen; fluorine; chlorine; OR¹¹; N(R¹²)(R¹³);

or a C₁-C₁₀ alkyl optionally substituted by hydroxy, fluorine, chlorine, mercapto, C₁-C₁₀ alkoxy, C₁-C₁₀ thioalkoxy or aryl;

R⁷ and R⁸ are each and independently selected from hydrogen; fluorine; chlorine; OR¹¹; N(R²)(R¹³); oxo;

or a C₁-C₁₀ alkyl optionally substituted by hydroxy, fluorine, chlorine, mercapto, C₁-C₁₀ alkoxy, C₁-C₁₀ thioalkoxy or aryl;

R⁹ and R¹⁰ are each and independently selected from hydrogen; fluorine; chlorine; C₁-C₁₀ alkyl; aryl; OR¹¹; or N(R¹²)(R¹³);

R¹¹ is selected from C(O)R¹⁴; C₁-C₁₀ alkyl; hydrogen;

or from an oxygen protecting group such as acetate, benzoate, benzyl, tert-butyl dimethylsilyl, triethyl silyl or triphenyl methane;

R¹² and R¹³ are each and independently selected from a C₁-C₁₀-alkyl; aryl; heteroaryl; hydrogen;

or a nitrogen-protecting group such as tert-butyloxycarbonyl, 9-fluorenylmethoxycarbonyl; a benzoyloxycarbamate or phtalimide;

R¹⁴ is selected from a linear or branched C₁-C₁₀ alkyl optionally substituted or interrupted by C₁-C₆ alkyl, aryl or heteroaryl;

or R¹⁴ is selected from a linear or branched C₁-C₁₀ alkoxy;

is prepared by reacting a compound of formula (VI)

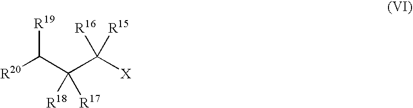

wherein

R¹⁵ and R¹⁶ are each and independently selected from hydrogen; fluorine; chlorine; OR²¹; N(R¹²)(R²³);

or a C₁-C₁₀-alkyl optionally substituted by hydroxyl, fluorine, mercapto, C₁-C₁₀-alkoxy, C₁-C₁₀-thioalkoxy or aryl;

R¹⁷ and R¹⁸ are each and independently selected from hydrogen; fluorine; chlorine; OR²¹; N(R²²)(R²³); oxo;

or a C₁-C₁₀ alkyl optionally substituted by hydroxy, mercapto, C₁-C₁₀ alkoxy, C₁-C₁₀ thioalkoxy or aryl;

R¹⁹ and R²⁰ are each and independently selected from hydrogen; fluorine; chlorine; C₁-C₁₀ alkyl; aryl; OR¹¹; or N(R¹²)(R¹³);

R²¹ is selected from C(O)R²⁴, hydrogen, a C₁-C₁₀ alkyl optionally substituted by hydroxyl, is fluorine or chlorine;

or an oxygen protecting group such as acetate, benzoate, benzyl, tert-butyl dimethylsilyl, triethyl silyl; or triphenyl methane;

R²² and R²³ are each and independently selected from a C₁-C₁₀-alkyl; aryl; heteroaryl; hydrogen;

or a nitrogen-protecting group such as tert-butyloxycarbonyl, 9-fluorenylmethoxycarbonyl; a benzoyloxycarbamate, or phtalimide;

R²⁴ is selected from a linear or branched C₁-C₁₀ alkyl optionally substituted or interrupted by C₁-C₆ alkyl, aryl, heteroaryl

or R²⁴ is selected from a linear or branched C₁-C₁₀ alkoxy;

X is a halogen selected from iodide or bromide;

with a hypophosphorous acid derivative, said reaction being radical initiated.

In still a further embodiment of the invention, a compound of formula VII

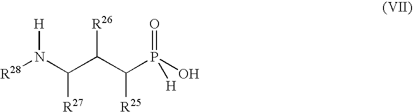

wherein

R²⁵ is selected from hydrogen; a linear or branched C₁-C₁₀-alkyl; a linear or branched C₁-C₁₀-alkoxy; fluorine or chlorine;

R²⁶ is selected from hydroxy; mercapto; fluorine; chlorine; oxo; a C₁-C₁₀-alkoxy or C(O)R²⁹;

R²⁷ is selected from hydrogen or a C₁-C₆ alkyl optionally substituted by hydroxy, mercapto, C₁-C₁₀-alkoxy, C₁-C₁₀-thioalkoxy or aryl;

R²⁸ is selected from hydrogen, C(O)R²⁹ or a C₁-C₁₀-alkyl optionally substituted with aryl;

R²⁹ is selected from a linear or branched C₁-C₁₀ alkyl optionally substituted or interrupted by C₁-C₆ alkyl, aryl, and heteroaryl;

or R²⁹ is selected from a linear or branched C₁-C₁₀ alkoxy;

is prepared by reacting a compound of formula VIII

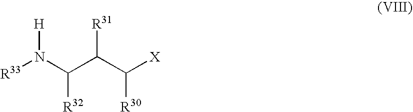

wherein

R³⁰ is selected from hydrogen; a linear or branched C₁-C₁₀-alkyl; a linear or branched C₁-C₁₀-alkoxy; fluorine or chlorine;

R³¹ is selected from hydroxy; mercapto; fluorine; chlorine; oxo; C₁-C₁₀-alkoxy or C(O)R³⁴;

R³² is selected from hydrogen; or a C₁-C₆-alkyl optionally substituted by hydroxy, mercapto, C₁-C₁₀-alkoxy, C₁-C₁₀-thioalkoxy or aryl;

R³³ is selected from hydrogen, C(O)R³⁴; or C₁-C₁₀-alkyl optionally substituted by aryl;

R³⁴ is selected from a linear or branched C₁-C₁₀ alkyl optionally substituted or interrupted by C₁-C₆ alkyl, aryl, or heteroaryl;

or R³⁴ is selected from a linear or branched C₁-C₁₀ alkoxy;

X is a halogen selected from iodide or bromide;

with a hypophosphorous acid derivative, said reaction being radical initiated.

In still a further embodiment of the present invention, a compound of formula VII

wherein

R²⁵ is hydrogen;

R²⁶ is fluorine;

R²⁷ is hydrogen;

R²⁸ is C(O)R²⁹; and

R²⁹ is tert-butoxy;

is prepared by reacting a compound of formula VIII

wherein

R³⁰ is hydrogen;

R³¹ is fluorine;

R³² is hydrogen;

R³³ is C(Q)R³⁴;

R³⁴ is tert-butoxy; and

X is iodide;

with a hypophosphorous acid derivative, said reaction being radical initiated.

In still a further embodiment, the hypophosphorous acid derivative used for the synthesis of a phosphinic acid is a compound or formula IX

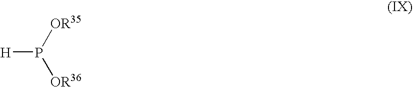

wherein

R³⁵ and R³⁶ are each and independently selected from a linear or branched C₁-C₁₀ alkyl or Si(R³⁷)₃;

R³⁷ is a C₁-C₆ alkyl.

Also other hypophosphorous acid derivatives are suitable for the radical initiated reaction, for example, compounds of formula X

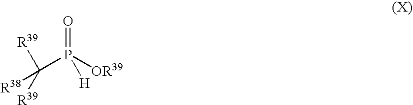

wherein

R³⁸ is selected from hydrogen; methyl or phenyl; and

R³⁹ is a linear or branched C₁-C₃ alkyl.

Also hypophosphorous acid derivative of formula XI may be suitable for the reaction of the invention

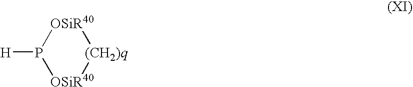

wherein

q is an integer of 1, 2 or 3;

R⁴⁰ is a linear or branched C₁-C₅ alkyl.

In the first reaction step of the process according to the present invention, step a), the hypophosphorous acid derivative bis(trimethyl silyl)hypophosphite is formed. The bis(trimethylsilyl)hypophosphite may be formed in different ways, for example, by reacting ammonium hypophosphite with trimethyl silyl chloride in the presence of an amine, such as diisopropyl ethyl amine (DIPEA), N-methylmorpholine or triethylamine, or by reacting ammonium hypophosphite with hexamethyl disilazan.

Unless otherwise stated the term “C₁-C₁₆ alkyl” as used throughout this specification is intended to include linear, branched or cyclic C₁-C₁₆ alkyl. Examples of C₁-C₁₆ alkyl are, but are not limited to, C₁-C₆ alkyl, methyl, ethyl, propyl, n-propyl, isopropyl, cyclic propyl, butyl, iso-butyl, sec-butyl, tert-butyl, cyclic butyl, pentyl, cyclic pentyl, hexyl and cyclic hexyl.

The term “C₁-C₁₀ alkyl” as used throughout this specification includes linear, branched or cyclic C₁-C₁₀ alkyl. Examples of C₁-C₁₀ alkyl include, but are not limited to, C₁-C₆ alkyl, methyl, ethyl, propyl, n-propyl, isopropyl, butyl, iso-butyl, sec-butyl, tert-butyl, pentyl and hexyl.

The term “cyclic C₃-C₆ alkyl” as used throughout this specification is intended to include cyclic propyl, cyclic butyl, cyclic pentyl, and cyclic hexyl.

Unless otherwise stated, the term “alkoxy” denotes an O-alkyl, wherein alkyl is as defined above. The term “C₁-C₁₀ alkoxy” as used throughout this specification includes linear, branched or cyclic C₁-C₁₀ alkoxy. Examples of C₁-C₁₀ alkoxy include, but are not limited to, C₁-C₆ alkoxy, methoxy, ethoxy, propoxy, n-propoxy, and tert-butoxy.

Unless otherwise stated, the term “thioalkoxy” denotes a S-alkyl, wherein alkyl is as defined above. The term “C₁-C₁₀ thioalkoxy” as used throughout this specification includes linear, branched or cyclic C₁-C₁₀ thioalkoxy. Examples of C₁-C₁₀ thioalkoxy include, but are not limited to, C₁-C₆ thioalkoxy, thiomethoxy, thioethoxy, thiopropoxy, n-thiopropoxy.

The term “C₁-C₁₆ alkylamine” as used throughout this specification includes linear, branched or cyclic C₁-C₁₆ alkylamine optionally substituted or interrupted by C₁-C₁₀ alkyl, aryl, hydroxy, mercapto, C₁-C₇ alkoxy, C₁-C₇ thioalkoxy, fluorine or chlorine.

The term “aryl” as used throughout this specification means an aromatic ring having from 6 to 10 carbon atoms, such as phenyl and naphtyl. The aryl may be substituted by C₁-C₆ is alkyl or halogens such as fluorine, chlorine and bromide.

The term “heteroaryl” as used throughout this specification means an aromatic ring in which one or more of the from 5-10 atoms in the ring are elements other than carbon, such as N, S and O. The heteroaryl may be substituted by C₁-C₆ alkyl or halogens such as fluorine, chlorine, and bromide

A suitable way of initiation radical reaction is by irradiation. A suitable source of irradiation is ultraviolet light, i.e. UV-irradiation. The radical reaction can be performed by the radiation from sunlight, but for a more efficient and controllable initiation of the reaction, an ultraviolet source may be used. The spectra of wavelengths for ultraviolet light typically extend from 40 nm to 400 nm. There are possibilities to make the initiation more specific, as a choice of a specific wavelength within this range is possible. The wavelength is an important parameter required by, for example, the substrates selected. By using ultraviolet irradiation as a radical initiator, a spectra of sources of ultraviolet light is available, for example, low pressure mercury lamp or medium pressure mercury lamp. Thus, depending on the substrates selected this might be an important parameter for an efficient reaction.

An example of a specific ultraviolet irradiation source is a low-pressure mercury lamp, which produces an ultraviolet light with a wavelength of approximately 254 nm.

The size and shape of the reaction vessel may require different arrangements for illuminating the reaction mixture. The illuminated surface area of the reaction mixture has been found to be a critical aspect, regarding efficiency, when using ultraviolet irradiation. The effect of the irradiation is limited to a few millimetres in the depth of the reaction mixture. Therefore, for a more efficient reaction the aim is to illuminate as large surface area as possible. Irradiation of the reaction mixture can be performed in different ways in order to illuminate as large surface area as possible. The position of the UV-source may therefore be critical. The source may be placed in the reaction mixture; the reaction mixture may be irradiated by placing the UV-source above the reaction vessel; or alternatively the walls of the reaction vessel may be irradiated or the reaction mixture may be pumped through a tube with a UV-source in the middle.

The synthesis of the phosphinic acids according to the present invention is performed at temperatures below room temperature, i.e. at a temperature below 20° C. The effect of having a lower temperature is that the various side reactions and the amount of by-products limiting the yield of the reaction are reduced. According to one embodiment of the invention, the reaction mixture is held at a temperature of 0° C. In a further embodiment of the invention, the reaction mixture is held at a temperature below −20° C. By lowering the reaction temperature to −60° C. an even higher yield can be achieved. Dehalogenation is a side reaction, which can occur. However, the dehalogenation is suppressed at lower temperature, and thus, the production of the sideproducts is suppressed.

An alkyl phosphinic acid which has been produced according to the present invention by adding the alkyl halide, which has been dissolved in a solvent, to a cooled solution comprising the hypophosphorous derivative in an inert environment, i.e. an environment free from oxygen attained by using nitrogen or argon. The reaction can be described in the following general way:

Alkyl halide+hypophosphorous acid derivative→alkyl phosphinic acid

The components for forming the hypophosphorous acid derivative, i.e. the hypophosphite group, are, for example, ammonium hypophosphite and hexamethyldisilazan, ammonium hypophosphite, diisopropylethyl amine and trimethylsilyl chloride. They are mixed in a vessel until the reaction is completed, the reaction mixture is then cooled and kept in an environment free from oxygen.

For example, when bis(trimethylsilyl)hypophosphite is being used as the hypophosphorous acid derivative, the first step of the synthesis for obtaining alkylphosphinic acids is the formation of bis(trimethylsilyl)hypophosphite. The formation of the hypophosphorous acid derivative just before the addition of the alkyl halide is an advantage since the hypophosphorous acid derivative is highly pyrophoric.

The alkyl halide is then added and the reaction is thereafter initiated by irradiation with ultraviolet light. The completion of the reaction is measured by, for example, HPLC or TLC.

During the process of the invention, a neutralisation of the hydrogen halide formed during the reaction can be performed by having a base present during the synthesis of the phosphinic acid. The base is suitably an amine such as, but not limited to, hexamethyldisilazan, N-methylmorpholine, triethylamine, or diisopropyl ethyl amine (DIPEA).

The reaction is conducted in non-polar or polar organic solvent, for example, toluene, methylene chloride, tetrahydrofuran, acetonitril or in a mixture thereof.

The compound formed is recovered by extraction in a polar solvent such as ethylacetate, isopropanol, n-butanol or a mixture thereof.

The compounds synthesised according to the claimed process of the present invention can form salts with bases. Salts with bases are, for example, alkali metal salts, e.g. sodium or potassium salts, or those with ammonia or organic amines.

The process according to the present invention is an efficient as well as an economical process for the preparation of alkylphosphinic acids. The following examples will further illustrate the invention, but is not intended to limit the scope of the invention as described herein or as claimed below.

### EXAMPLES

The following examples show the synthesis of (2R)-3-[(tert-butoxycarbonyl)amino]-2-fluoropropyl phosphinic acid from a reaction of an alkyl halide and the hypophosphorous acid derivatives bis-(trimethylsilyl) hypophosphite and hexamethyldisilazan. The examples are performed in order to show the effect of the initiation of the radical reaction, i.e. the reactions are performed in the presence or in the absence of a radical initiator. Also, synthesis of an alkylphosphinic acid in larger scale according to the invention is described.

### Example 1

### Bis-(trimethylsilyl)hypophosphite formed with trimethyl silyl chloride/diisopropyl ethylamine (DIPEA)

### Example 1A

### Reaction Initiated with Ultraviolet Light

An inert slurry was formed by mixing 1.4 g of ammonium hypophosphite (16.4 mmol) in 6 mL of toluene in a nitrogen atmosphere. 3.3 mL of diisoproylethyl amine (19.7 mmol) was added, followed by 4.6 mL of trimethylsilylchloride. The reaction mixture was held with stirring for 3 hours at room temperature. 1 g of tert-butyl(2R)-2-fluoro-3-iodo-propylcarbamate (3.3 mmol) dissolved in 2 mL of toluene was then added. The reaction mixture was irradiated with ultraviolet irradiation (6W low-pressure mercury lamp). The reaction was completed 3 hours after the start of reaction.

The reaction was quenched with ammonium hydroxide. The organic layer was discarded and the water phase is acidified with 4.5 M sulphuric acid to pH 2.1. The product was extracted into a 1:1 mixture of ethylacetate:isopropanol. The organic mixture was evaporated to give 1.4 grams of (2R)-3[(tert-butoxycarbonyl)amino]-2-fluoro-propyl phosphinate ammonium salt in an assay of 36%. Yield 59%.

### Example 1B

### Reaction Without Initiation

An inert slurry was formed by mixing 1.4 g of ammonium hypophosphite (16.4 mmol) in 6 mL of toluene. 3.3 mL of diisopropylethyl amine (19.7 mmol) was added, followed by 4.6 mL of trimethylsilylchloride. The reaction was held with stirring for 3 hours at room temperature. 1 gram of tert-butyl (2R)-2-fluoro-3-iodo-propylcarbamate (3.3 mmol), dissolved in 2 mL of toluene, was then added to the mixture. The reaction mixture was left with stirring in the dark (the reaction flask was kept inside a box). The reaction was almost completed after 26 hours.

The reaction was quenched with ammonium hydroxide. The organic layer was discarded and the water phase was acidified with 4.5 M sulphuric acid to pH 2.1. The product was extracted into a 1:1 mixture of ethylacetate:isopropanol. The organic mixture is evaporated, (2R)-3[(tert-butoxycarbonyl)amino]-2-fluoro-propyl phosphinate ammonium salt was obtained in almost the same amount and in a similar quality as in Example 1A.

### Example 2

### Bis(trimethylsilyl)hypophosphite Formed with Hexamethyldisilazan

### Example 2A

### Reaction Initiated by Ultraviolet Irradiation

An inert reaction mixture of 1.4 g of ammonium hypophosphite (16.4 mmol), 5 mL of hexamethyldisilazan and 4 mL of toluene was heated to 100° C. An opaque solution was formed after 3 hours, the solution was cooled to −20° C. 1 gram of tert-butyl (2R)-2-fluoro-3-iodo-propylcarbamate (3.3 mmol), dissolved in 2 mL of toluene, was added the reaction mixture and it was then irradiated with ultraviolet light (6 W low-pressure mercury lamp). The reaction was completed after 2 hours irradiation.

Adding ammonium hydroxide quenched the reaction. The organic layer was discarded and the water phase was acidified with 4.5 M sulphuric acid to pH 2.1. The product was extracted into a 1:1 mixture of ethylacetate:isopropanol. The organic mixture was evaporated to give 1.0 grams of (2R)-3[(tert-butoxycarbonyl)amino]-2-fluoro-propyl phosphinate ammonium salt in an assay of 54%. Yield 63%.

### Example 2B

### Reaction Without Initiation by Ultraviolet Irradiation

An inert reaction mixture of 1.4 g of ammonium hypophosphite (16.4 mmol), 5 mL of hexamethyldisilazan and 4 mL of toluene was heated to 100° C. An opaque solution was formed after 3 hours, the solution was cooled to −20° C. 1 gram of tert-butyl (2R)-2-fluoro-3-iodo-propylcarbamate (3.3 mmol), dissolved in 2 mL of toluene, was added the reaction mixture. The reaction mixture was left with stirring in the dark (the reaction flask was kept inside a box). The reaction was almost completed after 22 hours.

Adding ammonium hydroxide quenched the reaction. The organic layer was discarded and the water phase was acidified with 4.5 M sulphuric acid to pH 2.1. The product was extracted into a 1:1 mixture of ethylacetate:isopropanol. The organic mixture was evaporated, (2R)-3[(tert-butoxycarbonyl)amino]-2-fluoro-propyl phosphinate ammonium salt was obtained in almost the same amount and in a similar quality as in Example 2A.

### Example 3

### Synthesis of (2R)-3[(tert-butoxycarbonyl)amino]-2-fluoro-propyl phosphinate ammonium salt in large laboratory scale

An inert slurry was formed by mixing ammonium hypophosphite (69 g, 825 mmol) with hexamethyldisilazan (250 mL) in toluene (200 mL) and was heated to 100° C. under stirring in nitrogen atmosphere. An opaque solution was formed after 3 hours. The reaction solution was cooled to −20° C. tert-Butyl(2R)-2-fluoro-3-iodo-propylcarbamate (48 g, 154 mmol) dissolved in toluene (100 mL) was added the chilled solution. After completed addition, the radical reaction was initiated by a 125 W mercury medium pressure lamp. The reaction was detected completed (by LC) after 3 h. The reaction was quenched by addition of 500 mL, 12.5 % NH₄OH. A two-layer slurry was formed, which was allowed to obtain room temperature over night. Two clear phases were obtained the next day. The phases were separated; the water phase was added back to the reactor while the organic phase was discarded. The water phase was extracted two times with n-butanol (2×200 mL). The organic phases were combined and concentrated to approximately 100 mL. n-Butanol (100 mL) was added the formed slurry and the resulting slurry was heated to 60° C. Acetonitrile (200 mL) was added and the slurry was cooled to 0° C. The chilled slurry was filtered off, washed with acetonitrile and dried in vacuum at 40° C. 25 g of (2R)-3-[tert-butoxycarbonyl)amino]-2-fluoro-propyl phosphinic acid in an assay of 75% w/w was obtained. Yield: 47 %.

¹H NMR (CDCl3/CD3OD 1/1, δ in ppm) 7.0 (m, 1H, ¹J_{PH}=512 Hz, H-P), 4.78 (m, 1H, ²J_{HF}=43.4 Hz, H-2), 3.28 (m, 1H, H-3a), 3.21 (m, 1H, N—H amide), 3.15 (m, 1H, H-3b), 1.84 (m, 1H, H-1a), 1.64 (m, 1H, H-1b), 1.31(s, 9H, t-Bu) 19F NMR (CD3OD, δ in ppm) −182 (m, ³J_{PH}=21.1 Hz) 31P NMR (CD3OD, δ in ppm) 19.2 (m, ¹J_{PH}=512 Hz, ³J_{PH}=21.2 Hz)

### Example 4A

### Synthesis of Phenethyl Phosphinate Ammonium Salt with Ultraviolet Irradiation

2-Iodoethylbenzene (0.90 mL, 6 mmol) dissolved in methylene chloride (3 mL) was added to a solution of bistrimethylsilyl hypophosphite prepared as in example 2 a (4 equivalents) at −20° C. and a 125 W UW-lamp was used for illuminating the reaction mixture. The reaction showed complete disappearance of the starting material after 45 minutes and was quenched with NH₄OH/water, 1:1 (6 mL). The water phase was acidified with concentrated HCl and extracted with CH₂Cl₂ (2×30 mL). Upon evaporation the reaction yielded 810 mg (78%) of crude brown oil. The oil was dissolved in tert-butyl methyl ether and ammonia in methanol (7N) was added to afford 680 mg of white salt. Yield: 61%

### Example 4B

### Synthesis of Phenethyl Phosphinate Ammonium Salt Without Ultraviolet Irradiation

The reaction according to Example 4A was repeated without irradiation with the 125 W UV-lamp. After 20 hours the reaction was quenced and worked-up as above to afford 220 mg. Yield: 20%.

¹H NMR (D₂O,δ in ppm): 7.45-7.26 (m, 5H), 6.97 (d, 1H, J=505 Hz), 2.92-2.80 (m, 2H), 1.94-1.81 (m, 2H); ³¹P NMR (D₂O,δ in ppm): 29.39 (d, 505 Hz).

### Example 5A

### Synthesis of Cyclohexyl Phosphinate Ammonium Salt with Ultraviolet Irradiation

Cyclohexyl iodine (0.80 mL, 6 mmol) dissolved in methylene chloride (3 mL) was added to a solution of bistrimehtylsilyl hypophosphite prepared as in example 2 A (4 equivalents) at −20° C. and the irradiated with a 125 W UV-lamp. The reaction showed complete disappearance of the starting material after 40 minutes and was quenched with NH₄OH/water, 1:1 (6 mL). The water phase was acidified with concentrated HCl and extracted with methyl isobutyl ketone (3×30 mL). Upon evaporation there was a mixture of white solid and clear oil, the solid was filtered of to obtain a brown oil (340 mg, 2.29 mmol). The oil was dissolved in tert-butyl methyl ether ammonia in methanol (7N) was added to afford 300 mg of white salt. Yield: 31%.

### Example 5B

### Synthesis of of Cyclohexyl Phosphinate Ammonium Salt Without Ultraviolet Irradiation

Cyclohexyl iodine (0.80 mL, 6 mmol) dissolved in methylene chloride (3 mL) was added to a solution of bistrimethylsilyl hypophosphite prepared as in example 2a (4 equivalents) at 70° C. The reaction was quenched with NH₄OH/water, 1:1 (6 mL) and worked up as in example 5A after 11 days to afford 170 mg of white salt. Yield: 17 %.

¹H NMR (D₂O,δ in ppm): 6.53 (d, 1H, J=493 Hz), 1.84-1.50 (m, 5H), 1.38-0.95 (m, 6H); ³¹P NMR (D₂O,δ in ppm): 37.15 (d, 493 Hz)

### Example 6A

### Synthesis of 1-Adamantyl Phosphinic Acid with Ultraviolet Irradiation

1-iodoadamantane (1.61 g, 6 mmol) dissolved in toluene (3 mL) was added to a solution of bistrimethylsilyl hypophosphite prepared as in example 2a (4 equivalents) at −20° C. and irradiated with 125 W UV-lamp. The reaction showed complete disappearance of the staring material after 2 hours. The reaction was quenched with NH₄OH/water, 1:1 (6 mL). The water phase was acidified with concentrated HCl and extracted with CH₂Cl₂ (2×30 mL). Upon evaporation there was 380 mg of white crystals. Yield: 32%.

### Example 6B

### Synthesis of 1-Adamantyl Phosphinic Acid Without Ultraviolet Irradiation

1-iodoadamantane (1.61 g, 6 mmol) dissolved in toluene (3 mL) was added to a solution of bistrimethylsilyl hypophosphite prepared as in example 2a (4 equivalents) at 40° C. The reaction was quenched with NH₄OH/water, 1:1 (6 mL) and worked up as in example 6A after 6 days to afford 90 mg of white salt. Yield: 7%.

¹H NMR (CDCl₃, δ in ppm); ¹H: 6.20 (d, 1H, J=491 Hz), 1.87 (s, 3H), 1.76-1.48 (m, 12); ³¹P NMR (CDCl₃, δ in ppm): 41.65 (J=491 Hz).

### Example 7

### Large-Scale Process for Synthesizing (2R)-3[(tert-butoxycarbonyl)amino]-2-fluoro-propyl phosphinate ammonium salt

Ammonium hypophosphite (100 kg, 1204 moles, 5.0 equiv.) and toluene (305 kg, 351 L, 4.8 rel vol) was charged to a reactor at 20° C. and stirred under an N₂ atmosphere. The mixture was heated to 97° C. and hexamethyldisilazan (HMDS, 270.8 kg, 1678 moles, 7.0 equiv.) was charged slowly (13.5 hours) while keeping the temperature at 96±3° C. The reaction was left at 100° C. for 2 hours, and then it was cooled to −10° C. tert-Butyl(2R)-2-fluoro-3-iodo-propylcarbamate dissolved in toluene (72.7 kg, 240 moles, 223 L, 33% w/w) was added to the solution of BTHP at Tₘ≦−12° C. and the UV-lamp was ignited. The reaction was allowed to react until the IPC (LC) revealed 86.5% w/w formation of (2R)-3-[tert-butoxycarbonyl)amino]-2-fluoro-propyl phosphinic acid compared to remaining starting material (70 h). The lamp was switched off and subsequent addition of NH₄OH (25%, 211 kg, 12.9 equiv.) and water (212 kg, 2.9 rel vol) quenched the reaction (pH=8). The quenched reaction mixture was allowed to stir during 59 h before the obtained phases were separated and the organic phase was discarded. n-Butanol (232 kg, 286 L, 3.9 rel vol) was added to the water phase and the mixture was made acidic (pH=5) by addition of H₂SO₄ (4.5 M, 2.4+ an extra 1.8 equiv.). The phases were separated and the water phase was extracted once with n-butanol (230 kg, 284 L, 3.9 rel vol). After combining the n-butanol phases they were basified (pH=9) using ammonia (25%, 8 kg, 0.49 equiv.) and concentrated to 50%. Acetonitrile (231 kg, 292 L, 4.0 rel vol) was added to the concentrated organic solution at 64° C., the solution was cooled to 0° C. whereupon the product precipitated. The obtained crystals were isolated by filtration, washed with a mixture of acetonitrile (122 kg, 154 L, 2.1 rel vol) and n-butanol (125 kg, 154 L, 2.1 rel vol) and dried at 36-39° C. under reduced pressure, which gave (2R)-3 [(tert-butoxycarbonyl)amino]-2-fluoro-propyl phosphinate ammonium salt (40.6 kg, 77.6% w/w, 122 moles) in 51% yield.

1. A process for the synthesis of an alkyl phosphinic acid, the process comprising reacting an alkyl halide with a hypophosphorous acid derivative via a radical initiated reaction.

2. The process according to claim 1, wherein the process comprises the steps of:
a) mixing the hypophosphorous acid derivative and the alkyl halide; and
b) initiating the radical reaction.

3. The process according to claim 1, wherein the process comprises the steps of:
a) forming the hypophosphorous acid derivative;
b) adding the alkyl halide to the product of step a); and
c) initiating the radical reaction.

4. The process according to claim 1, wherein the radical initiated reaction is initiated by ultraviolet irradiation.

5. The process according to claim 1, wherein the alkyl phosphinic acid is a compound of formula I, 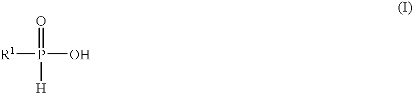
wherein:
R₁ is C₁-C₁₆ alkyl which is unsubstituted or optionally substituted or interrupted by one or more substituents selected from the group consisting of linear and branched C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine and chlorine;
or
R¹ is C₁-C₁₆ alkylamine which is unsubstituted or optionally substituted or interrupted by one or more substituents selected from the group consisting of C₁-C₁₀ alkyl, cyclic C₃-C₆ alkyl, aryl, heteroaryl, hydroxy, mercapto, C₁-C₁₀ alkoxy, C₁-C₁₀ thioalkoxy, fluorine, and chlorine.

6. The process according to claim 1, wherein the alkyl halide is a compound of formula II,
R¹—X (II)
wherein:
R₁ is C₁-C₁₆ alkyl which is unsubstituted or optionally substituted or interrupted by one or more substituents selected from the group consisting of linear and branched C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine, and chlorine;
or
R¹ is C₁-C₁₆ alkylamine which is unsubstituted or optionally substituted or interrupted by one or more substituents selected from the group consisting of C₁-C₁₀ alkyl, cyclic C₃-C₆ alkyl, aryl, heteroaryl, hydroxy, mercapto, C₁-C₁₀ alkoxy, C₁-C₁₀ thioalkoxy, fluorine, and chlorine.

7. The process according to claim 1, wherein the alkyl phosphinic acid is a compound of formula III, 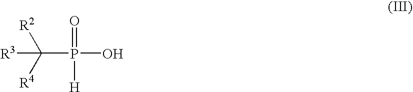
wherein:
R² is C₁-C₁₀ alkyl which is unsubstituted or optionally substituted or interrupted by one or more substituents selected from the group consisting of C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine, and chlorine;
or
R² is C₁-C₁₀ alkylamine which is unsubstituted or optionally substituted by one or more substituents selected from the group consisting of C₁-C₁₀ alkyl, aryl, heteroaryl, hydroxy, mercapto, C₁-C₁₀ alkoxy, C₁-C₁₀ thioalkoxy, fluorine and chlorine;
R³ and R⁴ are each independently selected from the group consisting of:
hydrogen;
C₁-C₆ alkyl which is unsubstituted or optionally substituted or interrupted by one or more substituents selected from the group consisting of C₁-C₆ alkyl, cyclic C₃-C₆ alkyl, aryl, heteroaryl, hydroxy, oxo, mercapto, C₁-C₆ alkoxy, C₁-C₆ thioalkoxy, fluorine and chlorine; and
C₁-C₆ alkylamine which is unsubstituted or optionally substituted or interrupted by one or more substituents selected from the group consisting of C₁-C₁₀ alkyl, aryl, heteroaryl, hydroxy, mercapto, C₁-C₁₀ alkoxy, C₁-C₁₀ thioalkoxy, fluorine, and chlorine.

8. The process according to claim 1, wherein the alkyl halide is a compound of formula IV, 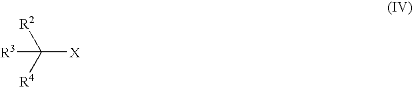
wherein:
R² is C₁-C₁₀ alkyl which is unsubstituted or optionally substituted or interrupted by one or more substituents selected from the group consisting of C₁-C₁₀ alkyl, cyclic C₃-C₆ alkyl, aryl, heteroaryl, hydroxy, oxo, mercapto, C₁-C₁₀ alkoxy, C₁-C₁₀ thioalkoxy, fluorine, and chlorine; or
R² is C₁-C₁₀ alkylamine which is unsubstituted or optionally substituted by one or more substituents selected from the group consisting of C₁-C₁₀ alkyl, aryl, heteroaryl, hydroxy, mercapto, C₁-C₁₀ alkoxy, C₁-C₁₀ thioalkoxy, fluorine, and chlorine; and
R³ and R⁴ are each independently selected from the group consisting of:
hydrogen;
C₁-C₆ alkyl which is unsubstituted or optionally substituted or interrupted by one or more substituents selected from the group consisting of C₁-C₆ alkyl, cyclic C₃-C₆ alkyl, aryl, heteroaryl, hydroxy, oxo, mercapto, C₁-C₆ alkoxy, C₁-C₆ thioalkoxy, fluorine, and chlorine; and
C₁-C₆ alkylamine which is unsubstituted or optionally substituted or interrupted by one or more substituents selected from the group consisting of C₁-C₁₀ alkyl, aryl, heteroaryl, hydroxy, mercapto, C₁-C₁₀ alkoxy, C₁-C₁₀ thioalkoxy, fluorine, and chlorine.

9. The process according to claim 1, wherein the alkyl phosphinic acid is a compound of formula V, 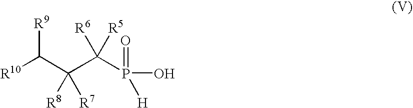
wherein:
R⁵ and R⁶ are each independently selected from the group consisting of hydrogen; fluorine; chlorine; OR¹¹; N(R¹²)(R¹³); and
C₁-C₁₀ alkyl which is unsubstituted or optionally substituted by one or more substituents selected from the group consisting of hydroxy, fluorine, chlorine, mercapto, C₁-C₁₀ alkoxy, C₁-C₁₀ thioalkoxy, and aryl;
R⁷and R⁸ are each independently selected from the group consisting of hydrogen; fluorine; chlorine; OR¹¹; N(R¹²)(R¹³); and
C₁-C₁₀ alkyl which is unsubstituted or optionally substituted by one or more substituents selected from the group consisting of hydroxy, fluorine, chlorine, mercapto, C₁-C₁₀ alkoxy, C₁-C₁₀ thioalkoxy, and aryl; or
wherein R⁷ and R⁸ together form an oxo group;
R⁹ and R¹⁰ are each independently selected from the group consisting of hydrogen; fluorine; chlorine; C₁-C₁₀ alkyl; aryl; OR¹¹; and N(R¹²)(R¹³);
R¹¹ is selected from the group consisting of C(O)R¹⁴; C₁-C₁₀ alkyl; hydrogen; and an oxygen protecting group;
R¹² and R¹³ are each independently selected from the group consisting of C₁-C₁₀ alkyl; aryl; heteroaryl; hydrogen; and a nitrogen-protecting group; and
R¹⁴ is linear or branched C₁-C₁₀ alkyl which is unsubstituted or optionally substituted or interrupted by one or more substituents selected from the group consisting of linear and branched C₁-C₆ alkyl, aryl, and heteroaryl,
or R¹⁴ is linear or branched C₁-C₁₀ alkoxy.

10. The process according to claim 1, wherein the alkyl halide is a compound of formula VI, 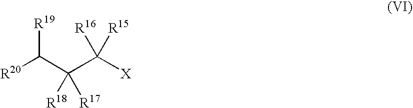
wherein:
R¹⁵ and R¹⁶ are each independently selected from the group consisting of hydrogen; fluorine; chlorine; OR²¹; N(R²²)(R²³); and C₁-C₁₀ alkyl which is unsubstituted or optionally substituted by one or more substituents selected from the group consisting of hydroxyl, fluorine, mercapto, C₁-C₁₀-alkoxy, C₁-C₁₀-thioalkoxy and aryl;
R¹⁷ and R¹⁸ are each independently selected from the group consisting of hydrogen; fluorine; chlorine; OR²¹; N(R²²)(R²³); and C₁-C₁₀ alkyl which is unsubstituted or optionally substituted by one or more substituents selected from the group consisting of hydroxy, mercapto, C₁-C₁₀ alkoxy, C₁-C₁₀ thioalkoxy, and aryl; or
wherein R¹⁷ and R¹⁸ together form an oxo group;
R¹⁹ and R²⁰ are each independently selected from the group consisting of hydrogen; C₁-C₁₀ alkyl; aryl; and N(R²²)(R²³);
R²¹ C(O)R²⁴; or C₁-C₁₀ alkyl which is unsubstituted or optionally substituted by one or more substituents selected from the group consisting of hydroxyl, fluorine, chlorine, hydrogen, and an oxygen protecting group;
R²² and R²³ are each independently selected from the group consisting of C₁-C₁₀ alkyl; aryl; heteroaryl; hydrogen; and a nitrogen-protecting group;
R²⁴ is linear or branched C₁-C₁₀ alkyl which is unsubstituted or optionally substituted or interrupted by C₁-C₆ alkyl, aryl, or heteroaryl; or
R²⁴ is linear or branched C₁-C₁₀ alkoxy; and
X is iodide or bromide.

11. The process according to claim 1, wherein the reaction temperature is below 20° C.

12. The process according to claim 11, wherein the reaction temperature is below 0° C.

13. The process according to claim 12, wherein the reaction temperature is below −20° C.

14. The process according to claim 1, wherein the hypophosphorous acid derivative is a compound of formula IX, 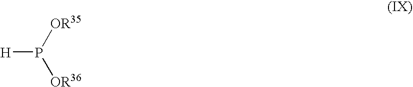
wherein:
R³⁵ and R³⁶ are each independently selected linear or branched C₁-C₁₀ alkyl or Si(R³⁷)₃;
and
R³⁷ is C₁-C₆ alkyl.

15. The process according to claim 1, wherein the hypophosphorous acid derivative is a compound of formula X, 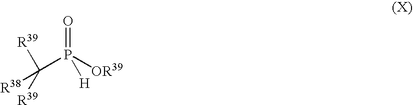
wherein:
R³⁸ is hydrogen, methyl, or phenyl; and
R³⁹ is linear or branched C₁-C₃ alkyl.

16. The process according to claim 1, wherein the hypophosphorous acid derivative is selected from a compound of formula XI, 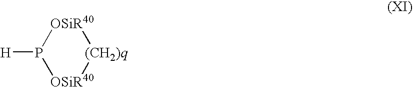
wherein:
q is an integer of 1, 2, or 3; and
R⁴⁰ is linear or branched C₁-C₅ alkyl.

17. The process according to claim 1, wherein the hypophosphorous acid derivative is bis-trimethylsilyl hypophosphite.

18. An alkyl phosphinic acid of formula I obtained by a process according to any one of claims 1 to 17.

19. A compound according to formula VII, 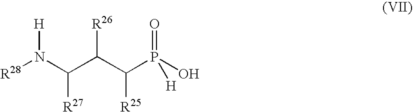
wherein:
R²⁵ is selected from the group consisting of hydrogen; linear or branched C₁-C₁₀ alkyl; linear or branched C₁-C₁₀-alkoxy; fluorine; and chlorine;
R²⁶ is selected from the group consisting of hydroxy; mercapto; fluorine; chlorine; oxo; C₁-C₁₀ alkoxy; and C(O)R²⁹;
R²⁷ is hydrogen; or a C₁-C₆ alkyl which is unsubstituted or optionally substituted by one or more substituents selected from the group consisting of hydroxy, mercapto, C₁-C₁₀ alkoxy, C₁-C₁₀-thioalkoxy and aryl;
R²⁸ is hydrogen; C(O)R²⁹; or linear, branched or cyclic C₁-C₁₀ alkyl which is unsubstituted or optionally substituted with aryl; and
R²⁹ is linear or branched C₁-C₁₀ alkyl which is unsubstituted or optionally substituted or interrupted by C₁-C₆ alkyl, aryl, or heteroaryl; or
R²⁹ is linear or branched C₁-C₁₀ alkoxy.

20. An alkylphosphinic acid according to formula VII, 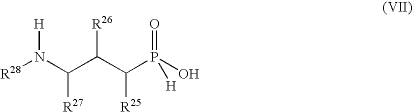
wherein:
R²⁵ is hydrogen;
R²⁶ is fluorine;
R²⁷ is hydrogen;
R²⁸ is C(O)R²⁹; and
R²⁹ is tert-butoxy.
